(19) United States
(12) Patent Application Publication
(10) Pub. No.: US 2006/0290456 A1
(43) Pub. Date: Dec. 28, 2006

(54) Intermediate frequency transformer

(76) Inventor: Dae hwan Jung, Masan (KR)

Correspondence Address: SQUIRE, SANDERS & DEMPSEY L.L.P, 600 HANSEN WAY, PALO ALTO, CA, 94304-1043, US

(21) Appl. No.: 11/424,545

(22) Filed: Jun. 16, 2006

(30) Foreign Application Priority Data
Jun. 23, 2005 (KR) 20-2005-18174

(51) Int. Cl. H01F 27/30

(52) U.S. Cl. 336/198

(57) ABSTRACT

Disclosed is an intermediate frequency transformer (IFT) with improved reliability, including a bobbin around which a coil is wound and a plurality of pins are arranged on the lower portion, and a ferrite core inserted into the center of the bobbin, wherein, the bobbin is made of a material that can withstand heat up to 245±40° C. for 20 seconds (reflow condition) and has an outer diameter of 3.5-7.5 mm; and wherein, an outer diameter of the ferrite core is in a range of 2.0 mm to 3.0 mm and has a screw formed on the outer peripheral surface thereof.

### CROSS-REFERENCE TO RELATED APPLICATIONS

This application claims benefit under 35 U.S.C. § 119 from Korean Patent Application No. 20-2005-18174 which was filed on Jun. 23, 2005, which is hereby incorporated by reference as if fully set forth herein.

### BACKGROUND OF THE INVENTION

1. Field of the Invention

The present invention relates in general to a transformer, more specifically, to an intermediate frequency transformer offering excellent quality and superior reliability through fine adjustment and minimal variation in core's position.

2. Description of the Related Art

In general, a transformer used in electrical and electronics applications such as TVs or VTRs is an electronic component that performs frequency conversion or frequency filtering for every type of tuner for use in electronic devices, and is categorized into IFTs (Intermediate Frequency Transfers), balun transformers, etc.

The IFT is a passive element for use in an intermediate frequency amplifier circuit in a superheterodyne receiver, and comprises a double-tuned or single-tuned circuit. It features a relatively wide range of bandwidth and good selectivity characteristic.

Inductance in the IFT is formed through wires and ferrite cores. To enhance product quality, a screw core and a pot core are sometimes used together for one transformer. Unfortunately however, this does not ensure reliability for a transformer because wire is made of only copper while the ferrite core contains more than five kinds of nonferrous metals besides ferrite, so the ferrite core shows a greater physical change by heat than the wire.

Therefore, to obtain an inductance, the wire is more advantageous than the ferrite core. Since the IFT is a variable coil, a screw type core is preferably used to a pot core, and a small, heat-resistance material is used for its stable performance.

In case of a conventional IFT having an outer diameter of 5.8 mm, the outer diameter of a core used therein ranged from 2.18 mm to 2.6 mm.

As shown in FIG. 1, a bobbin 1 of the transformer is made of a material that satisfies a heat-resisting property at 150-200° C. (reflow soldering condition like TPX). In addition, a 2.6 mm diameter hole is formed at the center of the bobbin 1, and 4-bobbin lines (control lines) 2 are formed in the hole.

However, if the pitch P1 of a screw core 3 is small, the screw core 3 is inserted into the hole being inclined by about 5°. This causes one of the bobbin lines 2 to be lost, and therefore the screw core 3 cannot stand upright.

Moreover, when the screw core is connected in its inclined condition, the resulting inductance becomes very unstable due to the expanded bobbin at high temperature under reflow condition. This gives rise to a fatal problem in reliability of the product.

### SUMMARY OF THE INVENTION

It is, therefore, an object of the present invention to provide an intermediate frequency transformer (IFT) that is capable of ensuring electrical reliability through a stable change in inductance.

To achieve the above objects and advantages, there is provided an intermediate frequency transformer (IFT) including a bobbin around which a coil is wound and a plurality of pins are arranged on the lower portion, and a ferrite core inserted into the center of the bobbin, wherein, the bobbin is made of a material that can withstand heat up to 245±40° C. for 20 seconds (reflow condition) and has an outer diameter of 3.5-7.5 mm; and wherein, an outer diameter of the ferrite core is in a range of 2.0 mm to 3.0 mm and has a screw formed on the outer peripheral surface thereof.

In an exemplary embodiment, 6 long and thin bobbin lines are protrusively formed on the inner peripheral surface of the bobbin at regular intervals from each other.

In an exemplary embodiment, the bobbin lines are formed 0.3 mm to 0.5 mm away from the top of the bobbin.

In an exemplary embodiment, the screw formed on the outer peripheral surface of the ferrite core has a pitch in a range of 0.15 mm to 0.30 mm.

In an exemplary embodiment, the outer diameter of the bobbin is 5.8 mm, the outer diameter of the ferrite core is 2.58 mm, and the outer diameter of the screw pitch is 0.25 mm.

In an exemplary embodiment, wherein length of the ferrite core is in a range of 2.3 mm to 3.0 mm.

In an exemplary embodiment, the bobbin is made of an LCP material.

### BRIEF DESCRIPTION OF THE DRAWINGS

The above aspects and features of the present invention will be more apparent by describing certain embodiments of the present invention with reference to the accompanying drawings, in which:

FIG. 1 is a cross-sectional view of a related art intermediate frequency transformer (IFT);

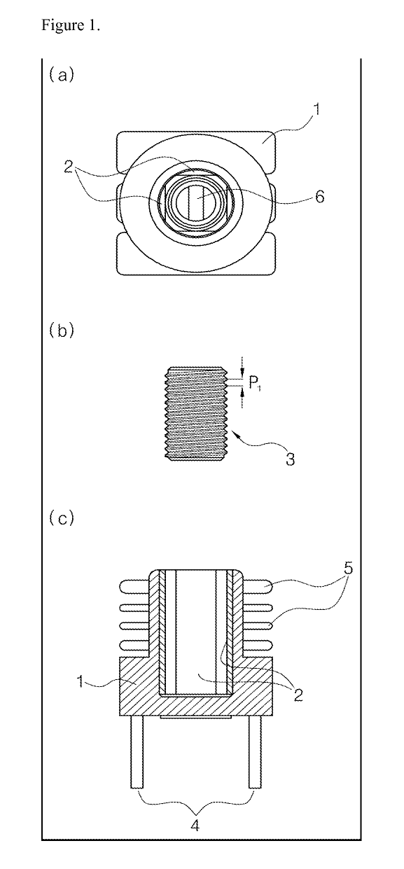

FIG. 2 is a sectional view of an IFT according to one embodiment of the present invention; and

FIG. 3 is a graph illustrating the change in torque according to length of a ferrite core, which relation being applied to one embodiment of the present invention.

### DETAILED DESCRIPTION OF THE PREFERRED EMBODIMENTS

A preferred embodiment of the present invention will be described herein below with reference to the accompanying drawings. The same components or like components are designated by the same reference numerals, and therefore the explanation of those components will be omitted hereafter.

The following now explains in detail a preferred embodiment of a transformer according to the invention, referring to the accompanying drawings.

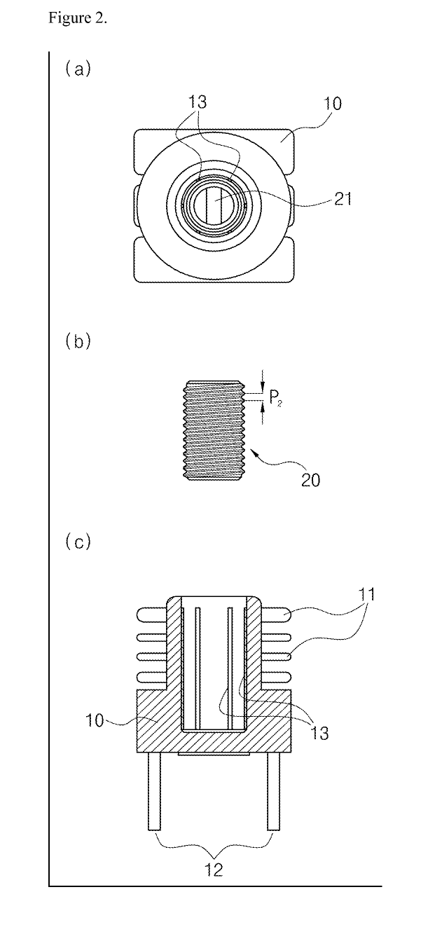

FIG. 2 is a sectional view of an intermediate frequency transformer (IFT) according to the present invention, in which FIG. 2(a) is a cross-sectional view of the IFT, FIG. 2(b) is a vertical sectional view of a core, and FIG. 2(c) is a vertical sectional view of a bobbin.

As shown in FIG. 2, the IFT includes a bobbin 10 and a ferrite core 20.

The bobbin 10 is made of an LCP(Liquid Crystal Polimer) material that can withstand heat up to 245±40° C. for 20 seconds (reflow condition), and has an outer diameter of 4.0-7.5 mm (desirably 5.8 mm). Below the bobbin 10 is a plurality of pins 12 fixedly arranged on a printed circuit board. Several winding lines 11, along which a coil (not shown) controlling an inductance is wound, are protrusively formed at a very small distance from each other on the outer surface of the bobbin 10 in a radial shape.

Moreover, a through hole or groove into which the ferrite core 20 is inserted is formed at the center of the bobbin 10 along a central axis, wherein the hole has a cross circular section having inside diameter of 2.0-3.0 mm. On the inner peripheral surface of the hole are formed six, long and thin bobbin lines 13 in the longitudinal direction at intervals of 60 degrees. In order to facilitate the insertion of the ferrite core 20, the 6 bobbin lines 13 are formed 0.3-0.5 mm (desirably 0.4 mm) away from the top of the bobbin 10.

The ferrite core 20 has a cylindrical shape to be inserted into the hole or groove formed at the center of the bobbin 10. To be more specific, a screw type core having screw threads formed on its peripheral surface is used as the ferrite core. In addition, the ferrite core 20 is made of LCPs (Liquid Crystal Polymers) offering excellent heat resistance and superior strength. Here, temperature factor of initial permeability (unit:∝ uir) of the ferrite core is in the range from −10/1,000,000-10/1,000,000 (20-60° C.).

Also, a straight adjusting groove 21 is formed on the upper and lower surfaces of the ferrite core 20, respectively, to enable one to insert and rotate a driver when the inductance changes.

The outer diameter of the ferrite core 20 ranges from 2.0 mm to 3.0 mm (desirably 2.58 mm) in order to reduce torque during its rotation. For fine adjustment, a screw pitch P2 formed on the outer peripheral of the ferrite core 20 is 0.15-0.30 mm (desirably 0.25 mm) in size.

Thusly constructed IFT is used for realizing clear image and sound on a TV. The transformer is usually set to 45.75 MHz frequency and 33 pF tuning capacity, and tolerance therefore is ±100 KHz.

Inductance of the IFT is about 430 nH±20 nH. Meanwhile, the inductance calculated by an equation, F=½π√(LC) (tolerance=±100 KHz), is ±2 nH. This inductance value is obtained when the ferrite core 20 rotates about 1/9 turn.

Since the screw pitch P2 of the core is 0.25 mm, if the movement of the core at −30-80° C. is greater than 0.03 mm in the vertical direction, a desired quality cannot be achieved. Moreover, because the inductance value is changed by 1-2 nH under the influence of temperature, the movement of the core due to heat or shock should be substantially zero.

Therefore, in order to maximize the effect according to a small pitch of the core 20, the bobbin 10 must be made of an LCP material with great hardness.

The following now describes the operation of the IFT with the above-described structure.

First of all, to assemble the IFT, a coil is wound to a proper number of turns until a desired inductance is obtained between the winding lines 11 formed on the outer surface of the bobbin 10, and both ends of the coil are connected to the pins 12 on the lower portion of the bobbin 10.

The screw type ferrite core 20 is then inserted into the center of the bobbin 10. To facilitate the insertion, one may tilt the ferrite core 20 slightly (about 5°) and push it to the mouth of the bobbin 10.

Since the formation of long and thin bobbin lines 13 does not start until about 0.4 mm away from the top of the bobbin 10, the insertion is not difficult up to that point.

When the ferrite core 20 is pushed deep inside the bobbin 10 by force, one of the bobbin lines 13 is damaged to some degree by its inclined edge. However, since there are 6 bobbin lines 13, not 4, formed inside the bobbin 10, the ferrite core 20, when inserted completely, can still stand upright by 5 bobbin lines 13, thereby securing reliability.

After the ferrite core 20 is inserted into the bobbin 10, the driver is inserted and rotated in the adjusting groove 21 that is formed in the ferrite core 20 to set desired impedance.

At this time, a plastic pot core is not used. In addition, because the screw pitch formed on the outer peripheral of the ferrite core 20 is as small as about 0.25 mm, the screw comes in contact with an extensive area of the inner peripheral surface of the bobbin 10 to some infinitesimal degree. Thus, variation in the ferrite core's position due to heat and shock is minimized, and therefore a change in inductance is minimized, which allows precise adjustment of the inductance.

Moreover, as the relatively small ferrite core 20 (about 2.58 mm), which is made of an LCP material offering excellent heat resistance and strength and can maximize delicate pitch effect by increasing the hardness of material, is inserted and rotated in the bobbin 10 with a large diameter (about 5.8 mm), a predetermined level of torque is generated. This makes it very easy to control inductance and prevent damage on the bobbin line 13 as much as possible.

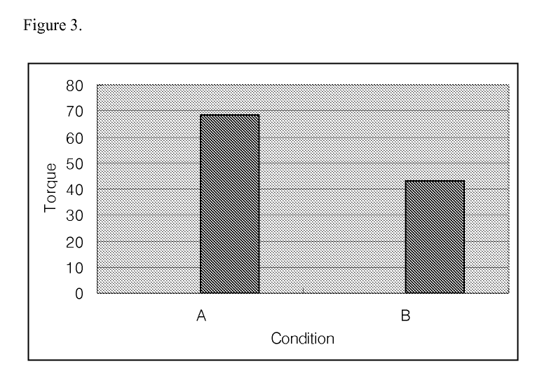

FIG. 3 graphically illustrates a relation between torques and lengths of the ferrite core, which relation being applied to one embodiment of the present invention. Here, the outer diameter of the core is set to 2.58 mm, and the outer diameter of the screw pitch is 0.25 mm.

Referring to FIG. 3, ‘A’ shows that 68 g/cm of torque is measured when the ferrite core is 2.8 mm long, while ‘B’ shows that 43 g/cm of torque is measured when the ferrite core is 1.8 mm long. In other words, torque was sharply increased as the length of the core increases. When the bobbin expands by heat, the torque is noticeably reduced. Also, when the ferrite core moves vertically inside the bobbin, inductance may be changed accordingly. Therefore, to prevent such problems, the torque at room temperature should be in the range from 60 g/cm to 80 g/cm, and a proper length of the ferrite core in that case falls within the range of 2.3 mm to 3.0 mm.

As described so far, the improved structure of the IFT of the present invention offers stable inductance by making the ferrite core stand perfectly upright and maintaining the torque thereof, excellent quality and superior electrical reliability of the product through fine adjustment and minimal variation in core's position due to heat and shock.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. An intermediate frequency transformer (IFT) comprising a bobbin around which a coil is wound and a plurality of pins are arranged on the lower portion, and a ferrite core inserted into the center of the bobbin,
wherein the bobbin is made of a material that withstand heat up to 245±40° C. for 20 seconds (reflow condition) and has an outer diameter of 3.5-7.5 mm, and an outer diameter of the ferrite core is in a range of 2.0 mm to 3.0 mm and has a screw formed on the outer peripheral surface thereof.

2. The IFT of claim 1, wherein the screw formed on the outer peripheral surface of the ferrite core has a pitch in a range of 0.15 mm to 0.30 mm.

3. The IFT of claim 2, wherein the outer diameter of the bobbin is 5.8 mm, the outer diameter of the ferrite core is 2.58 mm, and the outer diameter of the screw pitch is 0.25 mm.

4. The IFT of claim 1, wherein length of the ferrite core is in a range of 2.3 mm to 3.0 mm.

5. The IFT of claim 1, wherein 6 long and thin bobbin lines are protrusively formed on the inner peripheral surface of the bobbin at regular intervals from each other.

6. The IFT of claim 5, wherein the bobbin lines are formed 0.3 mm to 0.5 mm away from the top of the bobbin.

7. The IFT of claim 1, wherein the bobbin is made of an LCP(Liquid Crystal Polimer) material.
